(19) United States
(12) Patent Application Publication
(10) Pub. No.: US 2018/0244186 A1
(43) Pub. Date: Aug. 30, 2018

(54) FLUSH MOUNT SUPPORT SYSTEM FOR CARGO COMPARTMENT LOGISTICS TRACK

(71) Applicant: Ancra International LLC, Azusa, CA (US)

(72) Inventor: HOWARD T. KNOX, Cold Spring, KY (US)

(73) Assignee: Ancra International LLC, Azusa, CA (US)

(21) Appl. No.: 15/899,538

(22) Filed: Feb. 20, 2018

Related U.S. Application Data
(60) Provisional application No. 62/463,246, filed on Feb. 24, 2017.

(51) Int. Cl. B60P 1/64; B60P 7/15; B60P 7/08

(52) U.S. Cl. CPC B60P 1/64; B60P 7/0815; B60P 7/15

(57) ABSTRACT

A fixed track includes an aperture with an upper edge and a lower edge. An adapter includes a first tooth and a second tooth that define a first void and a second void. The adapter also includes at least one hole in at least one of the first tooth and the second tooth and at least one removable engagement device with a head positioned within the at least one hole. The adapter is configured to be received within the at least one aperture upon the fixed track such that the lower edge is received within one of the first void and the second void and the head of the engagement device is configured to interact with the upper edge so as to substantially prevent the adapter from being translated in a direction along a long axis of the aperture.

### CROSS-REFERENCE TO RELATED APPLICATIONS

This application claims priority from U.S. Provisional Application No. 62/463,246, filed on Feb. 24, 2017, the entirety of which is hereby incorporated by reference herein.

### TECHNICAL FIELD

This disclosure relates to structures and adapters configured for use with a logistic track system. The adapters permit the connection of various components and attachment devices to the adapter so as to permit the mounting of shelves, work benches and other such components to the adapter flush or near-flush with a wall of a cargo container.

### BRIEF SUMMARY

A representative embodiment of the disclosure is provided. The embodiment includes a system for removably connecting to a fixed track aligned with a plurality of spaced apertures aligned along a length of the track. An adapter is provided that includes a planar face that is configured to mate to the fixed track, the adapter comprising a rigid body with a width smaller than a width of one of the plurality of spaced apertures on the fixed track, the adapter further comprising a tooth that defines a bottom portion of the adapter, the adapter defines a void between the tooth and the planar face. The adapter is configured to be received within a first aperture of the plurality of spaced apertures upon the fixed track, such that a portion of the fixed track that defines a lower boundary of the first aperture of the plurality of spaced apertures is received within the void in the adapter.

Another embodiment of a removable adapter for use with the fixed track and the elongate rigid member includes a body with a width and a height. The adapter further includes a planar surface and a back surface spaced apart from the planar surface, a first end and a second end spaced apart from the first end. The adapter also includes a first tooth with a first height formed at one of the first end and the second end, the first tooth defining a first void. The adapter also includes a second tooth with a second height formed at the other of the first end and the second end opposite from the first tooth, the second tooth defining a second void. There is at least one hole in at least one of the first tooth and the second tooth and at least one removable engagement device positioned within the at least one hole, the engagement device including a head with a head height. The sum of the head height and one of the first height and the second height are less than or equal to the adapter height. Optionally, the adapter includes a stud that extends away from the planar surface.

In some embodiments, the adapter is configured such that when the adapter is received within the at least one aperture upon the fixed track, a lower edge of the at least one aperture is received within one of the first void and the second void in the adapter. The head of the engagement device is configured to interact with an upper edge of the at least one aperture so as to substantially prevent the elongate rigid member from being translated vertically with respect to the fixed track.

The adapter is configured to be coupled to various components such as decking, beams, shelving, work benches and the like either directly or indirectly (e.g., via a connector between the adapter and the component) so as to permit the various components to be mounted flush or near flush with a vertical wall of the cargo container.

Advantages of the disclosed devices will become more apparent to those skilled in the art from the following description of embodiments that have been shown and described by way of illustration. As will be realized, other and different embodiments are contemplated, and the disclosed details are capable of modification in various respects. Accordingly, the drawings and description are to be regarded as illustrative in nature and not as restrictive.

### BRIEF DESCRIPTION OF THE DRAWINGS

FIG. 1 is a side view of a fixed track within a cargo container.

FIG. 2 is a detail view of detail A of FIG. 1, shown in cross-section, with the fixed track and an embodiment of an adapter.

FIG. 3 is a rear view of the fixed track.

FIG. 4 is an exploded view of the adapter, and the fixed track.

FIG. 5 is a side view of another embodiment an adapter for use with the fixed track of FIGS. 1-4.

FIG. 6 is a top view of the adapter of FIG. 5.

FIG. 7 illustrates a top view of a cargo compartment with the embodiment of the fixed track and the adapter of FIGS. 5 and 6 coupled to an embodiment of a component.

FIG. 8 illustrates a cross-section A-A of the fixed track, adapter, and the component of FIG. 7.

FIG. 9 is a side view of yet another embodiment an adapter for use with the removable track and the fixed track of FIGS. 1-4.

FIG. 10 is a top view of the adapter of FIG. 9.

FIG. 11 illustrates an end view of a cargo compartment with the embodiment of the fixed track and the adapter of FIGS. 9 and 10 coupled to another embodiment of a component.

FIG. 12 illustrates a cross-section B-B of the fixed track, adapter, and the component of FIG. 11.

### DETAILED DESCRIPTION

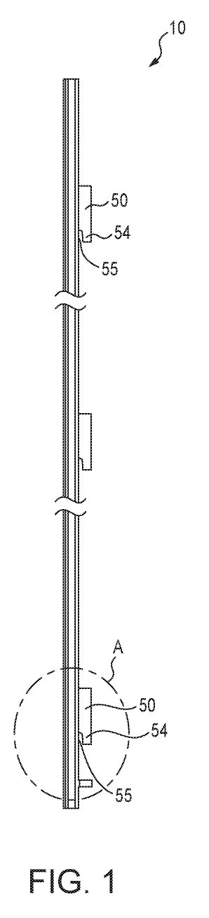

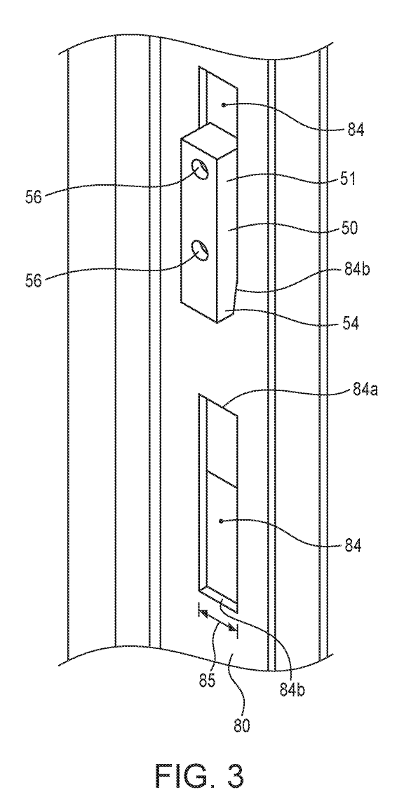

Turning now to FIGS. 1-4, a system 10 for removably connecting an elongate rigid member 20, such as a track, to a fixed logistics track 80 is provided. The fixed track 80 may be one of a plurality of lengths of stationary logistics track, such as “A” or “E” track, which are well known in the art. The logistics track is normally rigidly mounted to the walls or floor of a cargo container, or to a storage facility. In some embodiments, the track 80 comprises a vertically or horizontally aligned track that is mounted to the walls of the cargo compartment. The track 80 may have a plurality of apertures 84 that extend from a front surface 81 of the fixed track and through the track 80 to a rear surface 82 of the fixed track 80. The apertures 84 are disposed in a spaced relationship along the length of the track 80, such as at equal spacing from each other. As illustrated in FIGS. 1-4, the apertures 84 are oriented such that a long axis 86 of each aperture is parallel with and, in some embodiments, coincident with a long axis of the fixed track 80. In other embodiments (not illustrated), the long axis 86 of the apertures 84 are oriented at an angle to and, in some embodiments, substantially perpendicular (i.e., plus or minus 10 degrees from true perpendicular) to the long axis of the fixed track 80. In some embodiments the track 80 may be disposed in opposing pairs upon opposite walls of the cargo compartment. In some embodiments, a plurality of tracks 80 may be disposed upon each wall of the cargo compartment to allow for flexibility in the arrangement of the storage equipment therewithin, which is releasably mounted to the tracks 80 for desired storage and transport purposes. In some embodiments, and as best shown in FIG. 3, the fixed track 80 may include a central portion (the planar portion that includes the plurality of apertures 84 that is set of forward of the opposed sides of the track 80 (which contact the mounting surface) to create a space behind the central portion when the track 80 is mounted to a flat surface.

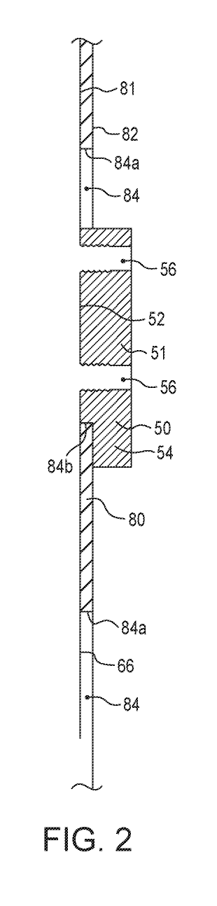

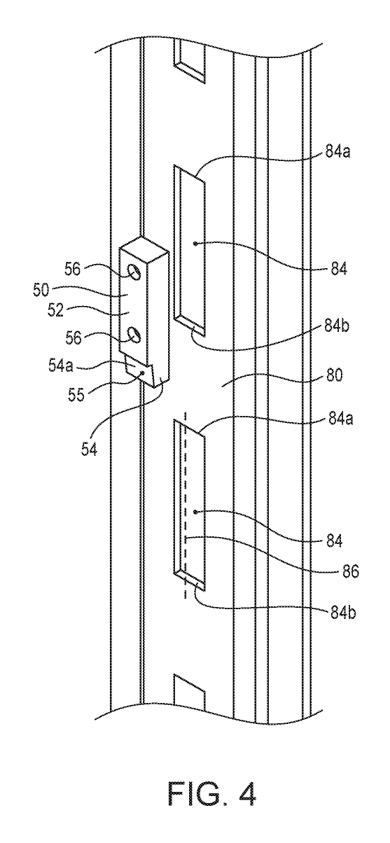

The adapter is best shown in FIGS. 2 and 4 and includes a body 51 and a tooth 54 that extends downwardly from the body 51. The body 51 defines a front surface 52 that is flush or near flush (i.e., within 0.1 inches) with the front surface 81 of the fixed track 80. The tooth 54 is formed with a depth less than the depth of the body 51 and the tooth 54 defines a void 55 between a front surface 54a of the tooth 54 and a plane that extends through the front surface 52 of the body 51. In some embodiments, the void 55 is formed with a depth just larger than a thickness of the material that forms the fixed track 80 (and specifically the thickness of the material forming the portion of the fixed track 80 that defines the plurality of apertures 84).

The body 51 of the adapter 50 may further include two or more holes 56, which may be through holes, or in other embodiments, may be blind holes that extend into the body from the front surface 52 of the adapter 50. In some embodiments the holes 56 may be tapped to receive the threads of a correspondingly threaded first fastener that may be used to couple the adapter to various components such as decking, beams, shelving, work benches and the like either directly or indirectly (e.g., via a connector between the adapter and the component).

As best understood with reference to FIGS. 2 and 3, the adapters 50 are configured to be received through respective apertures 84 in the fixed track 80. As can be appreciated with reference the figures, the width of the adapters 50 is best made to be just slightly narrower than the width of the aperture 84 (for embodiments where the apertures 84 are rectangular). Similarly, the height of the adapter 50, measured from the top surface of the body 51 to the opposite bottom surface of the tooth 54 must be smaller than the overall height of the aperture 84 to allow the adapter 50 to be inserted through the aperture 84. In some embodiments, the height of the adapter 50 is just smaller than the overall height of the aperture. The adapters 50 are positioned upon the fixed track 80 such that all of the adapters 50 extend through the respective apertures 84 in the fixed track 80 at the same time.

As shown in FIGS. 2 and 3, a surface of the tooth 54 (and the void 55 created by the tooth 54) is positioned to contact the rear surface 82 of the fixed track 80, with a portion of the fixed track 80 disposed within the void 55 after the adapters 50 extend through the respective apertures 84. As can be understood with view of FIG. 2, engagement between the lower edge 84b and the bottom surface of the body 51 limits the relative downward motion of the adapter 50 with respect to the fixed track 80.

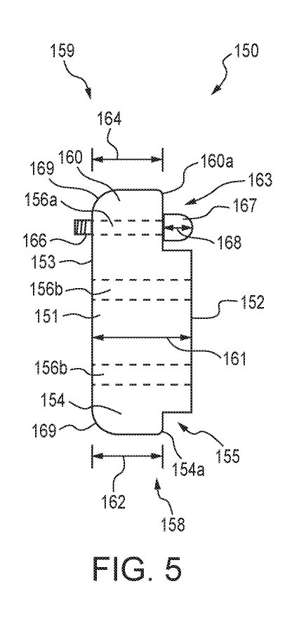

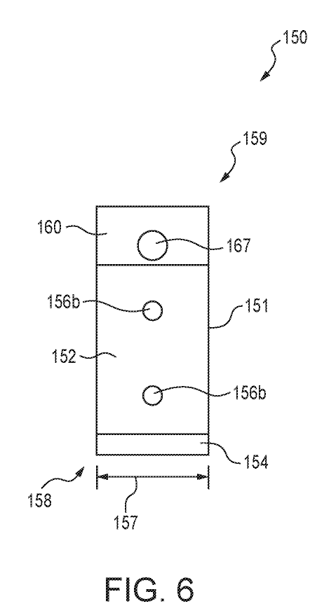

FIGS. 5 and 6 illustrate another embodiment of an adapter 150 for use with the fixed track 80 disclosed above. In some embodiments, the adapter 150 is configured to be coupled to one or more various components, such as decking, beams, shelving, work benches and the like either directly or indirectly (e.g., via a connector between the adapter and the component) as will be explained in greater detail below. The adapter 150 includes a body 151 with a width 157 smaller than a width 85 (FIG. 3) of the at least one aperture 84 on the fixed track 80.

A front or planar surface 152 of the body 151 lies flush or nearly flush with the front surface 81 of the fixed member 80, similar to the arrangement of the adapter 50 positioned within the fixed member 80 in FIG. 2. The adapter 150 also includes a back surface 153 spaced apart from the planar surface 152. The distance between the planar surface 152 and the back surface 153 defines an adapter height 161.

The adapter 150 includes a first end 158 and a second end 159 spaced apart from the first end 158. A first tooth 154 is formed at one of the first end 158 and the second end 159, although in FIGS. 5 and 6 the first tooth 154 is illustrated at the first end 158. The first tooth 154 defines a first void 155. The first tooth 154 includes a first height 162 that is less than the adapter height 161.

The adapter 150 also includes a second tooth 160 that is formed at the other of the first end 158 and the second end 159 opposite from the first tooth 154. In FIGS. 5 and 6 the second tooth 160 is illustrated at the second end 159. The second tooth 160 defines a second void 163. The second tooth 160 includes a second height 164 that is less than the adapter height 161.

The adapter 150 also includes at least one removable engagement device 166 removably positioned within at least one hole 156a in at least one of the first tooth 154 and the second tooth 160. The at least one hole 156a may be a blind hole, throughhole, threaded hole, or other variations. The at least one hole 156a may include a plurality of holes. In some embodiments, the at least one removable engagement device 166 is a threaded fastener, a screw, a bolt, a pin (whether a standard or cotter-style pin with a locking device at either end of the pin), and other similar fasteners and engagement devices.

The engagement device 166 includes a head 167 with a head height 168 that is less than the adapter height 161. The sum of the head height 168 and one of the first height 162 and the second height 164 is less than or equal to the adapter height 161. This feature (i.e., the sum of the height 168 of the engagement head 167 and the first and second heights 162, 164) enables the planar surface 153 and the head 167 of the engagement device 166 to remain flush or nearly flush with the upper surface 81 of the fixed track 80. This prevents the adapter 150 from encroaching upon the space within the cargo area.

As discussed, the adapter 150 is received within the at least one aperture 84 upon the fixed track 80 such that the lower edge 84b of the at least one aperture 84 is received within one of the first void 155 and the second void 163 in the adapter 150. The head 167 of the engagement device 166 is configured to interact with the upper edge 84a of the at least one aperture 84 so as to substantially prevent the adapter 150 from being translated in a direction along the long axis 86 of the aperture 80. Of course, the adapter 150 could be oriented such that the head 167 of the engagement device 166 is configured to interact with the lower edge 84b while the upper edge 84a of the at least one aperture 84 is received within one of the first void 155 and the second void 163 in the adapter 150. Optionally, a surface 154a, 160a of at least one of the first tooth 154 and the second tooth 160, respectively, contacts the rear surface 82 of the fixed track 80 when the adapter 150 is received within the at least one aperture 84.

Optionally, the adapter 150 includes at least one additional hole 156b in the body 151 of the adapter 150. In some embodiments, the at least one additional hole 156b includes a plurality of holes 156b. The at least one additional hole 156b may be a blind hole, throughhole, threaded hole, or other variations. In some embodiments, the at least one additional hole 156b is configured to receive a first fastener or threaded fastener that couples the adapter 150 to various components such as decking, beams, shelving, work benches and the like either directly or indirectly (e.g., via a connector between the adapter and the component).

Optionally, the adapter 150 includes at least one fillet 169 extending from the back surface 153 towards one of the first void 155 of the first tooth 154 and the second void 163 of the second tooth 160.

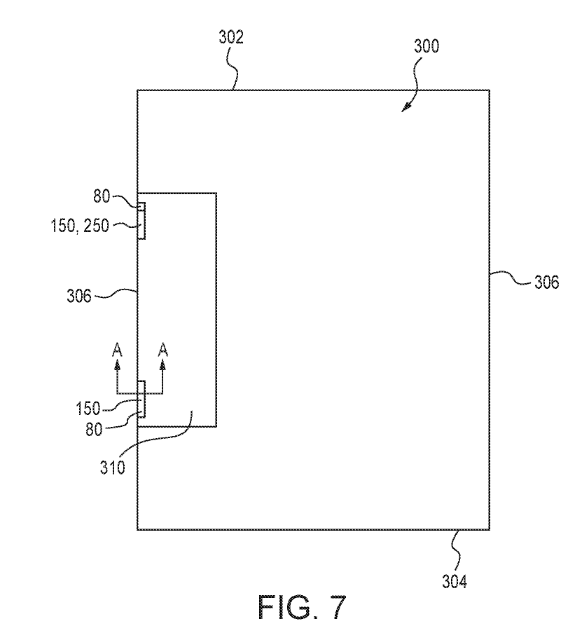

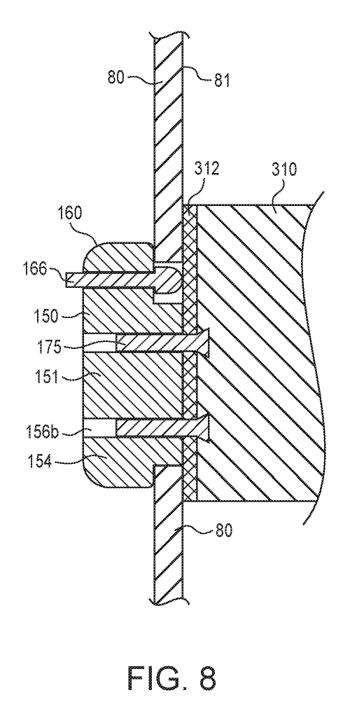

FIGS. 7 and 8 illustrate an embodiment of the fixed track 80 and the adapter 150, 250 (adapter 250 is discussed below) that is used to couple to various components such as decking, beams, shelving, work benches and the like either directly or indirectly (e.g., via a connector between the adapter and the component). As just one example, FIG. 7 illustrates a top view of a cargo compartment or container 300 with a front wall 302, a rear wall or door/opening 304, and two side walls 306. The fixed track 80 is coupled to one of the side walls 306, although the fixed track 80 could be coupled to both side walls 306. Two fixed tracks 80 are illustrated, although one or more than two fixed tracks 80 could be used.

The fixed track 80 and the adapters 150 or 250 may be used to couple a component 310, such as a work bench or shelf, to the side wall 306. FIG. 8 illustrate a partial cross-section A-A through one of the fixed tracks 80, an adapter 150, although the adapter 250 could be used, and the component 310.

FIG. 8 illustrates that the head 167 of the engagement device 166 and the planar surface 152 (not numbered in FIG. 8) are flush or nearly flush with the front surface 81 of the fixed track 80. Because the adapter 150 is flush or nearly flush with the fixed track 80, various components 310 can be coupled more closely to the wall 306 and the fixed track 80 than is otherwise possible with prior art track systems. For example, the component 310 may be flush or near flush (i.e., within 0.25 inches in this instance) with the front surface 81 of the fixed track 80 when the component 310 is coupled directly to the adapter 150.

The component 310, a work bench or shelf in this example, can be mounted directly or indirectly to the adapter 150 through various structures and connectors known in the art. For example, the component 310 may be coupled to the adapter directly via fasteners 175 inserted in one or more holes 156b. Alternatively, and as illustrated, a connector 312, such as a bracket, flange, coupling, or other similar device, may be positioned at least partially in between the adapter 150 and the component 310. The connector 312 may partially support the component 310, such as beam brackets, or it may simply act as an interface between the component 310 and the adapter 150.

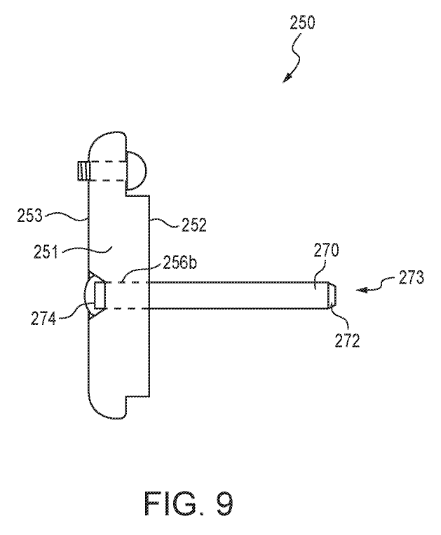

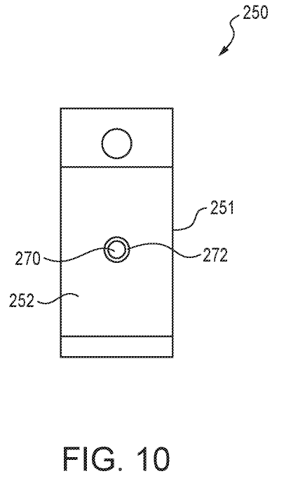

FIGS. 9 and 10 illustrate another embodiment of an adapter 250 for use with the fixed track 80 disclosed above. The adapter 250 optionally includes any combination of the features recited above with respect to the adapter 150 as is apparent from a comparison of FIGS. 5, 6, 9, and 10. Consequently, the following discussion focuses on the optional features and differences of the adapter 250 as compared to the adapter 150.

The adapter 250 includes a front or planar surface 252 of the body 251, which lies flush or near flush with the front surface 81 of the fixed track 80 as discussed above with respect to the adapters 50 and 150. The adapter 250 also includes a back surface 253 spaced apart from the planar surface 252.

The adapter 250 includes a stud 270 that extends away from the planar surface 252. The stud 270 may be circular, oval, square, rectangular, or any other shape in cross-section. In addition, the stud 270 may be solid, hollow (e.g., a tube), or include solid and hollow portions. The stud 270 optionally may include threads on an exterior surface of the stud 270 along all or a portion of the stud 270 and/or include threads along on all or a portion of an inner surface of the stud 270 in which the stud 270 is a tube or otherwise hollow. The stud 270 is optionally formed integrally with the body 251 of the adapter 250, welded to the adapter 250, coupled to the adapter 250 via a threaded connection within the hole 256b, coupled to the adapter 250 via a bolt and nut arrangement, coupled to the adapter 250 via a pin (e.g., cotter pin), or other methods of coupling the stud 270 to the adapter 250. Optionally, the stud 270 is substantially perpendicular to the planar surface 252 of the adapter 250. Substantially perpendicular is defined to mean within plus or minus 10 degrees of true or absolute perpendicularity, i.e., 80 to 100 degrees of angle relative to the planar surface 252. The stud 270 optionally includes a chamfered surface 272 at an end 273 distal from the planar surface 252.

In some embodiments, the stud 270 extends at least partially through at least one hole 256b in the body 251 of the adapter 250. The at least one hole 256b may be a blind hole, throughhole, threaded hole, and other variations. The at least one hole 256b may include a plurality of holes. Optionally, the hole 256b is countersunk on at least one of the back surface 253 and the planar surface 252 in the body 251 of the adapter 250. As illustrated in FIG. 9, the hole 256b is countersunk on the back surface 253 and includes a weld 274.

The stud 270 is used to interact and engage with various components of a logistic track system, including, but not limited, various beams that extend between logistic track systems positioned on opposite walls of a storage container.

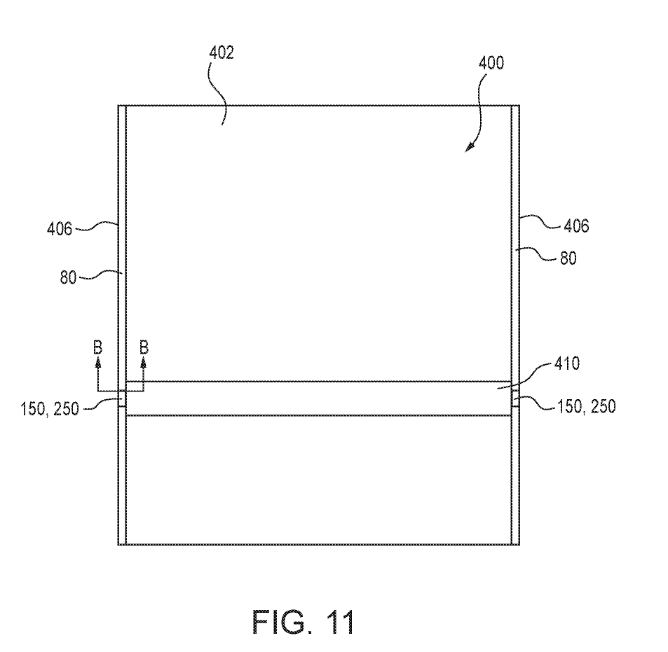

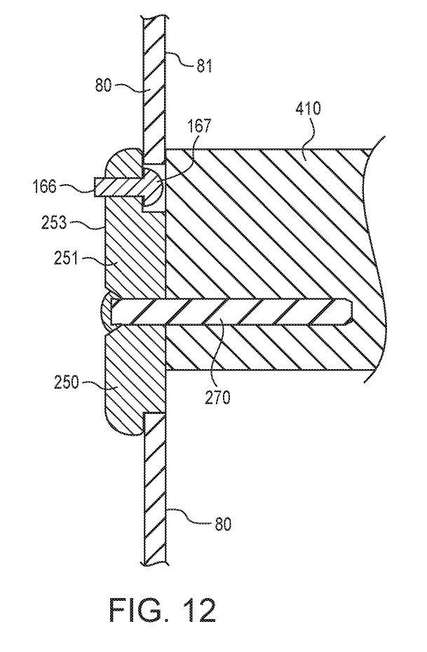

FIGS. 11 and 12 illustrate an embodiment of the fixed track 80 and the adapter 150, 250 that is used to couple to various components such as decking, beams, shelving, work benches and the like either directly or indirectly (e.g., via a connector between the adapter and the component). As just one example, FIG. 11 illustrates an end view (i.e., through the rear doors) into a cargo compartment or container 400 with a front wall 402 and two side walls 406. The fixed track 80 is coupled to both of the side walls 406, although the fixed track 80 could be coupled to just one of the side walls 406. Two fixed tracks 80 are illustrated, one each on opposing side walls 406, although one or more than two fixed tracks 80 could be used.

The fixed track 80 and the adapters 150 or 250 may be used to couple a component 410, such as a work bench, shelf, or in this example beams that extend across the cargo compartment 400 between the side walls 406. FIG. 12 illustrate a partial cross-section B-B taken into the page of FIG. 11 and through one of the fixed tracks 80 and an adapter 250, although the adapter 150 could be used.

FIG. 12 illustrates that the head 167 of the engagement device 166 and the planar surface 252 (not numbered in FIG. 12) are flush or nearly flush with the front surface 81 of the fixed track 80. Because the adapter 250 is flush or nearly flush with the fixed track 80, various components 410 can be coupled more closely to the wall 406 than is otherwise possible with prior art track systems. For example, the component 410 may be flush or near flush (i.e., within 0.25 inches in this instance) with the front surface 81 of the fixed track 80 when the component 410 is coupled directly to the adapter 250.

The component 410, a beam in this example, can be mounted directly or indirectly to the adapter 250 through various structures and connectors known in the art. For example, the component 410 may be coupled to the adapter 250 directly via fasteners. Alternatively or additionally to fasteners, the component 410 may rest directly upon the stud 270 or it may receive the stud 270 in a hole, slot, groove, or other receptacle in the component 410. For example, as illustrated in FIG. 12, the component 410 receives the stud 270 in a hole in the component 410 and is held in position in with an optional washer 414 and a fastening mechanism 412, such as a nut or other fastener that removably couples to the stud 270. Alternatively, although not illustrated, a connector, such as a bracket, flange, coupling, or other similar device, may be positioned at least partially in between the adapter 250 and/or the stud 270 and the component 410. The connector may partially support the component 410, such as beam brackets, or it may simply act as an interface between the component 410 and the adapter 250. A method of releasably engaging an adapter 150, 250 with a logistics track 80 is provided. The method includes providing one or more removable adaptors 150, 250 disposed such that a planar surface or front surface 152, 252 is flush or near flush with the front surface 81 of the fixed track 80. The adapters 150, 250 may be coupled to the fixed track 80 via engagement of a tooth 154, 155 with one or both of the upper edge 84a and the lower edge 84b of an aperture 84 in the fixed track 80. More specifically, the fixed track 80 includes a plurality of apertures 84 that are distributed in (preferably in a uniform spacing manner) along the length of the track 80. The adaptors 150, 250 are disposed in alignment with respective apertures 84 from the plurality of apertures such that the adapters 150, 250 each slide within an aperture 84 in the fixed track 80.

With respect to the adapters 150, 250, a fastener 166 is then engaged through the at least one hole 156a. Preferably, the fastener 166 is disposed in contact with or in close proximity to the upper edge 84a of the respective aperture 84 to prevent relative translation of the adapter 150, 250 in a direction along an axis 86 of the fixed track 80. When the adapter 150, 250 is desired to be removed, the fastener 166 may be removed, which allows the adapter 150, 250 to be moved upwardly with respect to the fixed track 80, which disengages the fixed track 80 from one of the first void 155 and the second void 163 proximate to the first tooth 154 and the second tooth 160, respectively, and allows the plurality of adapters 150, 250 to slide out of the respective plurality of apertures 84.

The methods also include couple the adapters 150, 250, when coupled to the fixed track 80, to various components such as decking, beams, shelving, work benches and the like either directly or indirectly (e.g., via a connector between the adapter and the component).

While the preferred embodiments of the disclosure have been described, it should be understood that the disclosure is not so limited and modifications may be made without departing from the invention. The scope of the invention is defined by the appended claims, and all devices that come within the meaning of the claims, either literally or by equivalence, are intended to be embraced therein.

1. A releasable mounting system for a cargo container, comprising:
a fixed track configured to be rigidly mounted to a vertical wall of a compartment, the fixed track comprising at least a front surface and a rear surface spaced apart from the front surface and at least one aperture aligned along a length of the first track extending between the front surface and the rear surface, wherein the at least one aperture is defined in part by a lower edge and an upper edge and wherein the aperture includes a long axis;
an adapter comprising:
a body with a width smaller than a width of the at least one aperture on the fixed track;
a planar surface adjacent to the rear surface of the elongate rigid member;
a back surface spaced apart from the planar surface;
a first end and a second end spaced apart from the first end;
a first tooth formed at one of the first end and the second end, the first tooth defining a first void;
a second tooth formed at the other of the first end and the second end opposite from the first tooth, the second tooth defining a second void;
at least one hole in at least one of the first tooth and the second tooth;
at least one removable engagement device positioned within the at least one hole, the engagement device including a head;
wherein the adapter is configured to be received within the at least one aperture upon the fixed track such that the lower edge of the at least one aperture is received within one of the first void and the second void in the adapter and wherein the head of the engagement device is configured to interact with the upper edge of the at least one aperture so as to substantially prevent the adapter from being translated in a direction along the long axis of the aperture.

2. The system of claim 1, wherein a surface of at least one of the first tooth and the second tooth lies adjacent the rear surface of the fixed track when the adapter is received within the at least one aperture.

3. The system of claim 1, wherein the adapter comprises an adapter height, wherein the first tooth comprises a first height, wherein the second tooth comprises a second height, wherein the head of the engagement device comprises a head height, and wherein the sum of the head height and one of the first height and the second height are less than or equal to the adapter height.

4. The system of claim 1, wherein the adapter includes at least one additional hole in the body of the adapter.

5. The system of claim 4, wherein the at least one additional hole is a throughhole.

6. The system of claim 1, wherein the adapter further comprises a stud that extends away from the planar surface.

7. The system of claim 6, wherein the stud extends at least partially through at least one throughhole in the body of the adapter.

8. The system of claim 7, wherein the at least one throughhole is countersunk on at least one of the back surface and the planar surface in the body of the adapter.

9. The system of claim 6, wherein the stud is welded to the adapter.

10. The system of claim 6, wherein the stud is substantially perpendicular to the planar surface.

11. The system of claim 1, wherein the adapter includes at least one fillet extending from the back surface towards one of the first void of the first tooth and the second void of the second tooth.

12. The system of claim 1, wherein the at least one aperture comprises a plurality of apertures, and wherein the adapter is two or more adapters that are spacingly mated to the fixed track.

13. The system of claim 1, further comprising a component coupled one of directly and indirectly to the adapter, and wherein the component is one of a shelf, a work bench, a beam, and a decking.

14. A removable adapter for use with a fixed track mounting system for a cargo container, comprising:
a body with a width and a height;
a planar surface;
a back surface spaced apart from the planar surface;
a first end and a second end spaced apart from the first end;
a first tooth with a first height formed at one of the first end and the second end, the first tooth defining a first void;
a second tooth with a second height formed at the other of the first end and the second end opposite from the first tooth, the second tooth defining a second void;
at least one hole in at least one of the first tooth and the second tooth; and,
at least one removable engagement device positioned within the at least one hole, the engagement device including a head with a head height, and wherein the sum of the head height and one of the first height and the second height are less than or equal to the adapter height.

15. The removable adapter of claim 14, further comprising at least one additional hole in the body of the adapter.

16. The removable adapter of claim 14, wherein the adapter further comprises a stud that extends away from the planar surface.

17. The removable adapter of claim 16, wherein the stud extends at least partially through at least one throughhole in the body of the adapter.
